(19) United States
(12) Patent Application Publication
(10) Pub. No.: US 2017/0160882 A1
(43) Pub. Date: Jun. 8, 2017

(54) ELECTRONIC APPARATUS AND CONTROLLING METHOD THEREOF

(71) Applicant: SAMSUNG ELECTRONICS CO., LTD., Suwon-si (KR)

(72) Inventors: Joo-yong PARK, Seoul (KR); Sang-bong LEE, Hwaseong-si (KR)

(21) Appl. No.: 15/355,314

(22) Filed: Nov. 18, 2016

(30) Foreign Application Priority Data
Dec. 7, 2015 (KR) 10-2015-0173142

(51) Int. Cl. G06F 3/0482; G06F 3/14; G06F 3/0488; G06F 3/0346; G06F 3/01

(52) U.S. Cl. CPC G06F 3/0482; G06F 3/0346; G06F 3/017; G06F 3/0488; G06F 3/1423

(57) ABSTRACT

An electronic apparatus and a method of controlling the electronic apparatus are disclosed. An aspect of an example embodiment relates generally to an electronic apparatus including communication circuitry configured to communicate with an external apparatus, a display configured to display a first display, and a processor configured to control the communication circuitry to provide the first display of the electronic apparatus on the external apparatus and, in response to a display being selected among a plurality of displays displayed on the external apparatus and the selected display not being the first display, to control the display to display a second display to control the external apparatus while transmission of the first display is maintained.

This application is based on and claims priority under 35 U.S.C. §119 to Korean Patent Application No. 10-2015-0173142, filed in the Korean Intellectual Property Office on Dec. 7, 2015, the disclosure of which is incorporated by reference herein in its entirety.

### BACKGROUND

1. Field

The present disclosure relates generally to an electronic apparatus and a controlling method thereof, and for example, to an electronic apparatus which can control a sink apparatus while a mirroring operation is maintained and a controlling method thereof.

2. Description of Related Art

Recently, thanks to developed mobile environments, various contents which can be displayed on a mobile apparatus are provided. However, since a size of display panel is small due to a feature of a mobile apparatus, mirroring technology which is sharing the display panel with a screen of a big display apparatus has been developed.

Existing mirroring technology is encoding display data of a source apparatus which is paired on a wired/wireless communication network in real time, transmitting the data in a packet form, decoding the data in a sink apparatus and displaying the data. In other words, the existing mirroring technology includes transmitting a display displayed on a source apparatus to a sink apparatus as it is and the sink apparatus displaying the received display as it is.

In the existing mirroring technology, the mirroring service should be stopped in order to perform a function of the sink apparatus in the middle of the mirroring service. In addition, the source apparatus can be used only in controlling the source apparatus in the mirroring service.

### SUMMARY

Example embodiments relate to an electronic apparatus which can selectively control a source apparatus or a sink apparatus in the middle of a mirroring service and a controlling method thereof.

According to an example embodiment, an electronic apparatus is provided, the electronic apparatus including a communicator comprising communication circuitry configured to communicate with an external apparatus, a display configured to display a first display and a processor configured to control the communication circuitry to provide the first display on the external apparatus and, in response to a display being selected from among a plurality of displays displayed on the external apparatus and the selected display not being the first display, to control the display to display a second display to control the external apparatus while transmission of the first display is maintained.

According to an example embodiment, a method of controlling an electronic apparatus is provided, the method including displaying a first display, providing the first display on an external apparatus, selecting a display among a plurality of displays displayed on the external apparatus, and in response to the selected display not being the first display, displaying a second display on the electronic apparatus to control the external apparatus while transmission of the first display is maintained.

According to the various example embodiments, even if a separate input apparatus does not exist additionally, a user can control both a source apparatus and a sink apparatus.

### BRIEF DESCRIPTION OF THE DRAWINGS

The above and other aspects of the disclosure will become more apparent and readily understood from the following detailed description, taken in conjunction with the accompanying drawings, in which like reference numerals refer to like elements, and wherein:

FIGS. 1A and 1B are diagrams illustrating an example display system performing mirroring according to an example embodiment;

FIG. 2 is a block diagram illustrating an example configuration of an electronic apparatus according to an example embodiment;

FIG. 3 is a block diagram illustrating an example configuration of an electronic apparatus according to an example embodiment;

FIGS. 4 to 7 are diagrams illustrating example display selecting methods according to various example embodiments;

FIGS. 8A and 8B are diagrams illustrating examples of displaying UIs for selecting a display according to various example embodiments;

FIG. 9 is a diagram illustrating an example method of an electronic apparatus controlling a cursor of an external apparatus according to an example embodiment;

FIGS. 10A and 10B are diagrams illustrating examples of control UIs to control an external apparatus according to an example embodiment; and

FIGS. 11 and 12 are flowcharts illustrating example controlling methods of an electronic apparatus according to various example embodiments.

### DETAILED DESCRIPTION

Example embodiments hereinafter are explained and described in greater detail with reference to the drawings. For reference, when it is determined that the detailed description of the known function or configuration may obscure the gist of the example embodiments in describing them, a detailed description thereof may be omitted. Terms used hereinafter are terms defined by functions of the present disclosure being considered, and definitions may vary according to a user, an operator or a custom. Therefore, definitions of the terms should be made with reference to overall contents of the present disclosure.

Although terms such as “first” and “second” may be used to explain various elements, the elements should not be limited by these terms. The terms are used simply to distinguish one element from other elements. For example, a first element may be named a second element without departing from the scope of the various example embodiments of the present disclosure, and similarly, a second element may be referred to as a first element. The term “and/or” includes a combination of a plurality of described relevant items or any item of a plurality of described relevant items.

Terms used in the present disclosure are used simply to describe example embodiments rather than limiting the present disclosure. Singular forms are intended to include plural forms unless the context clearly indicates otherwise. It should be understood that terms such as “comprise” or “consist of” as used herein designate presence of characteristics, numbers, steps, operations, elements, components or a combination thereof described herein, and do not foreclose the presence or possibility of addition of one or more other characteristics, numbers, steps, operations, elements, components or a combination thereof.

In addition, the term “application” in the example embodiments may refer, for example, to a set of computer programs designed to perform a specific function. Applications can be embodied in various kinds in the example embodiments. For example, the application may include a game application, a moving image replay application, a map application, a memo application, a calendar application, a phone book application, a broadcast application, an exercise support application, a payment application, a photo folder application, and the like, but is not limited to these.

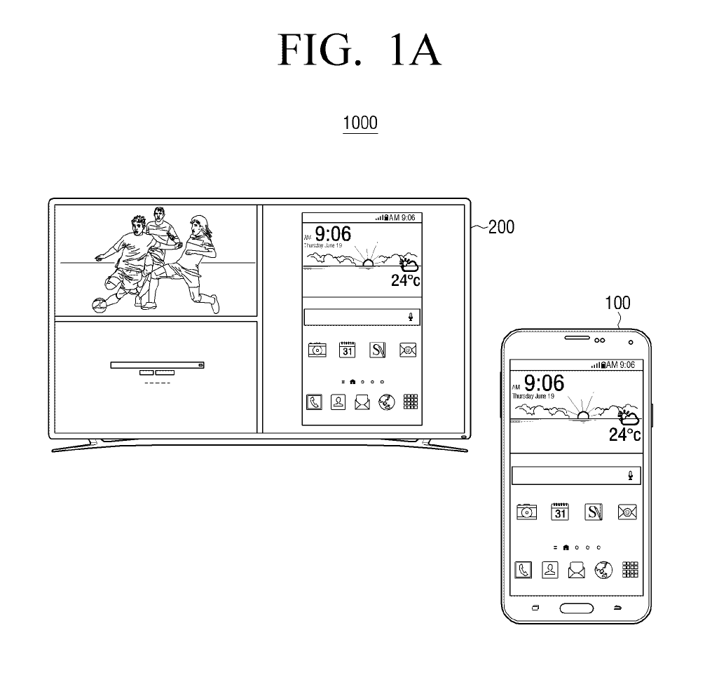

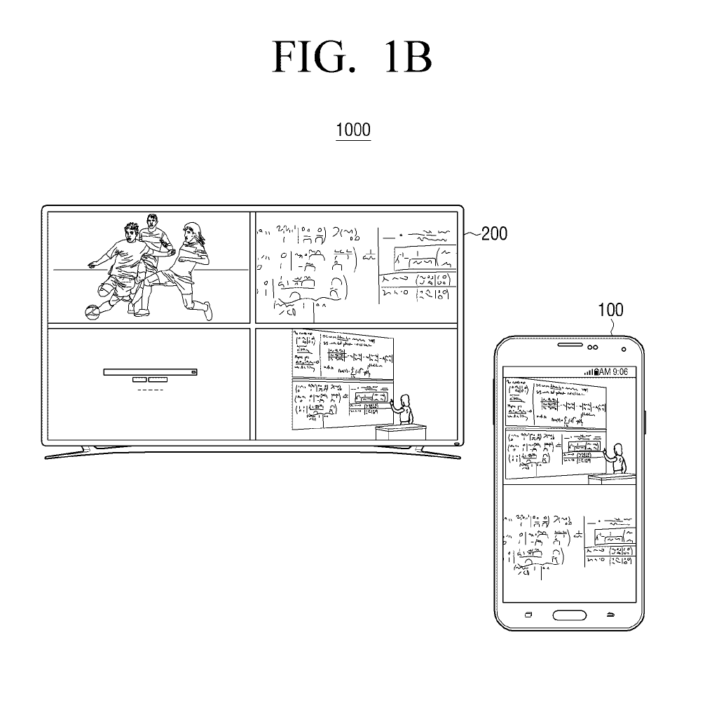

FIGS. 1A and 1B are diagrams illustrating an example display system performing mirroring according to an example embodiment. FIGS. 1A and 1B illustrate that a display system includes an electronic apparatus 100 which provides an image and an external apparatus 200 which is provided with the image.

The electronic apparatus 100 which provides an image in a mirroring service may be referred to in different ways, such as a source apparatus and a master apparatus. The external apparatus 200 which is provided with the image in the mirroring service may be referred to in different ways, such as a sink apparatus and a client apparatus.

In FIGS. 1A and 1B, the electronic apparatus 100 is illustrated as a smartphone and the external apparatus 200 is illustrated as a smart TV. However, the electronic apparatus 100 and the external apparatus 200 can be embodied as various apparatuses which can display an image such as a smartphone, a lap top, a personal computer (PC), a personal digital assistant (PDA), an electronic book terminal, a digital broadcast terminal, a kiosk, an electronic frame, a GPS navigation, a smart TV, and wearable apparatus such as a smart watch or a head-mounted display (HMD), or the like, and is not limited thereto.

The electronic apparatus 100 and the external apparatus 200 according to an example embodiment may be apparatuses which can include a composition of multiple displays. The electronic apparatus 100 which can have the composition of multiple displays may, for example, be an apparatus in which at least one application is driven at the same time such as a mobile apparatus. The external apparatus 200 which can have the composition of multiple displays may, for example, be an apparatus which can display a web-page as well as existing broadcasting programs at the same time.

According to an example embodiment, the electronic apparatus 100 may search for a display which is to be displayed based on a mirroring start command. The electronic apparatus 100 may provide the display identified by the search to the external apparatus 200. The external apparatus 200 which may have the composition of multiple displays may display at least one display which displays a content that the external apparatus 200 itself provides as well as a mirroring display which is transmitted from the electronic apparatus 100. Referring to FIG. 1A, the external apparatus 200 may, for example, display the mirroring display transmitted from the electronic apparatus 100 at the right side of a display and displays for a broadcasting program and a web browser on the left side of the display. For example, an area where the mirroring display is displayed on the external apparatus 200 may be referred to as a mirroring window and an area where the external apparatus 200 displays its own display may be referred to as a non-mirroring window.

According to an example embodiment, the electronic apparatus 100 may select a display from among a plurality of displays displayed on the external apparatus 200. If the selected display is a mirroring display, the electronic apparatus 100 may control the mirroring display. On the other hand, if the selected display is not a mirroring display, the electronic apparatus 100 may display a UI to control the external apparatus 200 on its own display. Even though the electronic apparatus 100 according to an example embodiment displays a UI to control the external apparatus 200, a part pertaining to the UI may not be mirrored. Accordingly, the electronic apparatus 100 may control the external apparatus 200 without affecting the mirroring display displayed on the external apparatus 200.

According to an example embodiment, as illustrated in FIG. 1B, the electronic apparatus 100 may mirror a plurality of sub displays. The electronic apparatus 100 may search for displays which are to be displayed based on a mirroring start command. The electronic apparatus 100 may separate the displays identified by the search into a plurality of sub displays. FIG. 1B illustrates that in the electronic apparatus 100, two sub displays which can be independently processed are separated and displayed as an upper display and a lower display. The electronic apparatus 100 may provide information regarding the sub displays and each of the sub displays to the external apparatus 200. Information regarding the sub displays may refer, for example, to at least one piece of information on a size, a location on a display of the electronic apparatus 100 and image quality. The external apparatus 200 may display a plurality of transmitted sub displays. There is no need for a display composition of the external apparatus 200 to be same as a display composition of the electronic apparatus 100. As illustrated in FIG. 1B, the external apparatus 200 may have a composition of up and down sub displays which may be different from a composition of up and down sub displays displayed on the electronic apparatus 100.

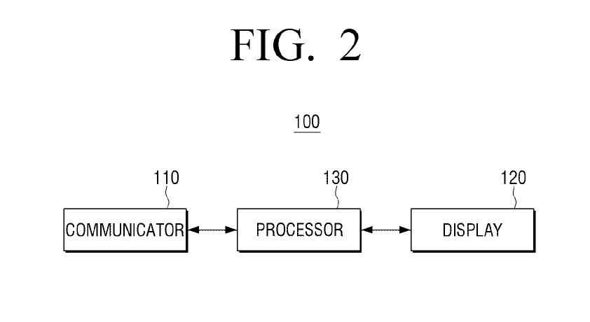

FIG. 2 is a block diagram illustrating an example configuration of the electronic apparatus 100 according to an example embodiment. FIG. 2 illustrates that the electronic apparatus 100 includes a communicator (e.g., including communication circuitry) 100, a display 120 and a processor 130.

The communicator 110 includes various communication circuitry configured to communicate with the external apparatus 200. The communication circuitry of the communicator 110 may, for example, transmit encoded data to the external apparatus 200. The communicator 110 may transmit a control signal for the external apparatus 200 input through a control UI to the external apparatus 200. The communicator 110 may mix the control signal and the data in which display data is encoded together and encode the mixed data. For example, the data in which display data is encoded may indicate data in which data of a display excluding the control UI was encoded. Therefore, the control UI is displayed on the electronic apparatus 100 and the control UI may not be displayed on the external apparatus 200.

The display 120 may display a display. The display may include content received from an external source or a pre-stored content. In addition, the display may include various objects such as an icon, text, an image, etc. The various objects may interact with a user and may include a UI element which can give a visual feedback, an audio feedback or an olfactory feedback based on a user input.

The processor 130 may control the rest of the elements of the electronic apparatus 100. For example, the processor 130 may control the circuitry of the communicator 110 to provide the external apparatus 200 with a display displayed on the display 120. The processor 130 may select a display among a plurality of displays displayed on the external apparatus 200. If the selected display is not a mirroring display provided from the electronic apparatus 100 (in other words, if the selected display is a display of the external apparatus 200 itself), the processor 130 may control the display 120 to display a control UI to control the external apparatus 200 while a transmission of a mirroring display is maintained. Accordingly, the external apparatus 200 may continuously display a mirroring display which excludes the control UI and the electronic apparatus 100 may display a display including the control UI.

If the selected display is not a display provided by the electronic apparatus 100, the processor 130 may control the display 120 to display a display including a control UI corresponding to a content of the selected display. For example, if the selected display is a display for a TV broadcasting program, the processor 130 may control the display 120 to display a control UI which is a form of a TV remote controller. For another example, if the selected display is a display for web browser, the processor 130 may control the display 120 to display a control UI which is a form of a keyboard. If the selected display is a web-browser display, the processor 130 may control the display 120 to display a control UI of a form of a direction key with four directions or a touch screen to control a cursor displayed on the external apparatus 200.

Using information received through the communication circuitry of the communicator 110 regarding respective contents of a plurality of displays displayed on the external apparatus 200, the processor 130 may determine what kind of control UI should be displayed.

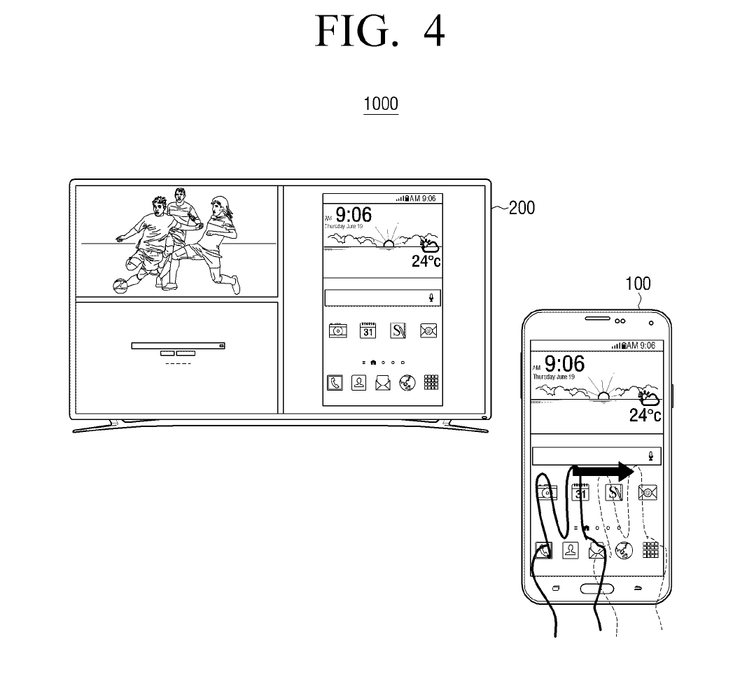

In order to control the external apparatus 200, the processor 130 may select a display which is not a mirroring display among a plurality of displays displayed on the external apparatus 200. For example, the processor 130 may control the display 120 to display a display for receiving selection of a display among a plurality of displays that the external apparatus 200 displays. For another example, even though the external apparatus 200 does not display a display for receiving selection of a display among a plurality of displays that the external apparatus 200 displays, the processor 130 may select a display. More detailed explanations will be provided below with reference to FIGS. 4 to 6.

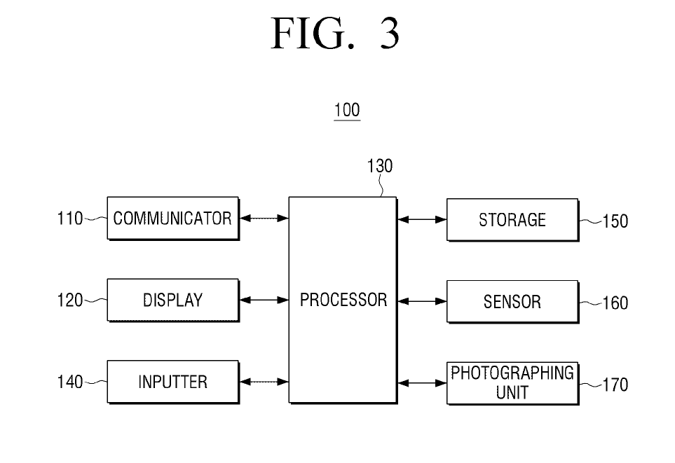

FIG. 3 is a block diagram illustrating an example configuration of the electronic apparatus 100 according to an example embodiment. FIG. 3 illustrates that the electronic apparatus 100 includes the communicator (e.g., including communication circuitry) 110, the display 120, the processor 130, an inputter (e.g., including input circuitry) 140, a storage 150, a sensor 160 and a photographing unit (e.g., including photographic circuitry) 170. However, the electronic apparatus 100 according to an example embodiment is not limited to the example embodiment including all of the elements described above. For example, the electronic apparatus 100 may also include an additional element which is not illustrated in FIG. 3.

The communicator 110 may include various communication circuitry configured to transmit at least one piece of display data for mirroring and a control signal to control the external apparatus 200 to the external apparatus 200. The communication circuitry of the communicator 110 may transmit data in which display data and the control signal are mixed to the external apparatus 200. The communicator 110 may transceive data with the external apparatus 200 through a wired and/or wireless network.

For example, the communicator 110 may include communication circuitry using various methods such as, for example, and without limitation, Near Field Communication (NFC), a Wireless LAN, an Infrared (IR), Zigbee, Wireless Fidelity (WI-FI), Bluetooth (BT), etc. The communicator 110 may use a method of mobile communications system (e.g., Global System for Mobile Communications (GSM), Universal Mobile Telecommunications System (UMTS), Long-term evolution (LTE), Wireless Broadband Internet (WiBRO), etc.). The communicator 110 may include various communication circuitry using wired communications system such as, for example, and without limitation, High Definition Multimedia Interface (HDMI), Low Voltage Differential Signaling (LVDS), Local Area Network (LAN), Universal Serial Bus (USB), etc.

The display 120 may display at least one among various image-processed video frames or graphic-processed displays. For example, the display 120 may, if a plurality of applications are executed, display a plurality of displays which can be independently processed.

The manner of embodying the display 120 is not limited and, for example, the display 120 may be embodied in various forms such as a liquid crystal display (LCD), an organic light emitting diodes (OLED), an active-matrix organic light-emitting diode (AM-OLED), a plasma display panel (PDP), or the like, but is not limited thereto. The display 120 may additionally include an element according to an embodying type. For example, if the display 120 is embodied in a liquid crystal method, the display 120 may include an LCD display panel (not illustrated), a backlight unit (not illustrated) which provides a light to the LCD display panel and a panel driving substrate (not illustrated) which drives a panel (not illustrated).

The display 120 may include a touch screen which may, for example, include a mutually layered composition with a touch pad and the touch screen may detect a location, an area and pressure of a touch input. In this case, the display 120 may perform a function of the inputter 140 at the same time.

The display 120 may be combined with at least one area of a front area, side areas and a rear area of the electronic apparatus 100 in a form of a bended display. The bended display may be embodied as a flexible display or may be embodied as a general display which is not flexible. For example, the bended display may be embodied with a plurality of flat displays which are connected to each other.

If the bended display is embodied as a flexible display, the flexible display may have feature of being twisted, bended or rolled as if a sheet of paper through a thin and flexible substrate without damage. The flexible display may be manufactured using a plastic substrate as well as a glass substrate which is generally used. When the plastic substrate is used, a low temperature manufacturing process may be used instead of an existing manufacturing process to avoid damage on the substrate. The flexible display may have a flexibility by which the display may be folded or unfolded by replacing a glass substrate which covers a liquid crystal display on an LCD, an OLED, an AM-OLED, a PDP, or the like, with a plastic film, but is not limited thereto. Such a flexible display may be thin, light and even resistant to an impact or a shock, and can be twisted or bended. The flexible display also may be embodied in various forms.

The inputter 140 may include various input circuitry configured to receive a request, a command or other data from a user to control an operation of the electronic apparatus 100. In addition, when a control UI is displayed to control the external apparatus 200, the inputter 140 may receive a request, a command or other data to control an operation of the external apparatus 200. For example, the inputter 140 may be include various input circuitry, such as, for example, and without limitation, a key pad, a mouse, a touch panel, a touch screen, a track ball, a jog switch, or the like.

The storage 150 may store various programs and data necessary for operating the electronic apparatus 100. The storage 150 may be embodied as a flash memory, a hard disk, etc. For example, the storage 150 may be equipped with read-only memory (ROM) to store a program for performing an operation of the electronic apparatus 100, random-access memory (RAM) to temporarily store data according to an operation execution of the electronic apparatus 100, etc. Electrically erasable and programmable ROM (EEPROM) to store various reference data may be further equipped with.

The storage 150 may store a program and data for various display compositions which are to be displayed on the display 120. The storage 150 may store a program and data to perform a mirroring service.

The sensor 160 may include various sensors or sensing circuitry configured to sense various user interactions. The sensor 160 may include various kinds of sensors and include at least one device among all types of sensing devices that can sense a condition change of the electronic apparatus 100. For example, the sensor 160 may include at least one of a touch sensor, an acceleration sensor, a gyro sensor, an illumination sensor, a proximity sensor, a pressure sensor and a noise sensor.

According to an example embodiment, the sensor 160 may sense a direction in which the electronic apparatus 100 is tilted. The processor 130 may select a display among a plurality of displays displayed on the external apparatus 200 according to a sensed direction in which the electronic apparatus 100 is tilted.

For example, the sensor 160 may detect a direction in which the electronic apparatus 100 is tilted using an acceleration sensor. The acceleration sensor senses an amount of change in speed per unit time (maybe per second, per minute or per hour, etc). The acceleration sensor may be embodied with three axis. In case of the three axis acceleration sensor, the sensor has X, Y and Z acceleration sensors which are arranged in different directions and mutually cross at right angles. The acceleration sensor converts respective output values of the X, Y and Z acceleration sensors into respective digital values and provides the digital values to a previous processing unit. Here, the previous processing unit may include a chopper circuit, an amplifier circuit, a filter, an A/D converter, etc. Accordingly, an electric signal outputted from the three axis acceleration sensor is chopped, amplified and filtered, and then the signal is converted to a digital voltage value.

For another example, the sensor 160 may further include a velocity sensor, a geomagnetic sensor, and the like besides the acceleration sensor. By combining values measured in various kinds of sensors, the sensor 160 may more exactly distinguish a movement condition of the electronic apparatus 100.

The velocity sensor senses a velocity by sensing an amount of change in a pre-set direction of the electronic apparatus 100 during a unit time. The velocity sensor may use a gyroscope which has three axis.

The geomagnetic sensor can detect azimuth by detecting a flow of a magnetic field. The geomagnetic sensor may detect coordinates of the electronic apparatus 100 and a direction in which the electronic apparatus 100 is laid based on the coordinates.

The geomagnetic sensor may detect a geomagnetic field in a method of measuring a voltage value which is induced by the geomagnetic field by using a flux gate. The geomagnetic sensor may, for example, be embodied with two or three axis. In this example, since geomagnetic output values calculated by respective axis of the geomagnetic sensor vary according to a size of periphery magnetic field, it is general to carry out a normalization which is mapping geomagnetic output values within a pre-set range (for example, −1 to 1). The normalization is carried out by using a normalization factor such as a scale value or an offset value. In order to calculate a normalization factor, a geomagnetic sensor should be rotated for a plurality of times and values outputted therefrom should be detected, and then the maximum value and the minimum value should be detected from the output values. The normalized value by using a normalization factor is used for an operation of azimuth amendment.

The photographing unit 170 may receive an input of a gesture command from a user. For example, the photographing unit 170 may be embodied as a camera. By photographing a movement of a user by using the camera, the photographing unit 170 may receive an input of a gesture command of the user. If the inputted gesture of the user pertains to a pre-set gesture command, the processor 130 may select a display among a plurality of displays displayed on the external apparatus 200 according to the pre-set gesture command.

According to various the example embodiments, convenience of using a mirroring service among display apparatuses that can provide multiple displays can be improved. For example, a user may automatically use the mirroring service on each area without a special input. By simply selecting each area, a user may control an operation based on a content provided from each area.

According to the various example embodiments, since data regarding a mirroring display and control UI data are separated and processed, the problem of possible interruption on display watching which is caused from a control UI being displayed together on the mirroring display of the sink apparatus may be addressed.

FIGS. 4 to 6 are diagrams illustrating example display selecting methods according to various example embodiments. For example, FIGS. 4 to 6 illustrate that a selective control ownership may be moved or changed without a separate UI for receiving selection of a display among a plurality of displays displayed on the external apparatus 200. The selective control ownership is a term that may be to express that the electronic apparatus 100 can selectively control one of the electronic apparatus 100 and the external apparatus 200 based on whether a display is a mirroring display or not.

Instead of displaying a separate UI for receiving selection of a display among a plurality of displays displayed on the external apparatus 200, an operation of triggering which causes the electronic apparatus 100 to recognize that a movement for selecting a display is input may be included. The triggering may be performed in various ways such as a certain gesture input, a motion input, a voice input, a certain application's execution, etc.

After mirroring between the electronic apparatus 100 and the external apparatus 200 is performed, the electronic apparatus 100 may receive a command for selecting a display among a plurality of displays displayed on the external apparatus 200. According to an example embodiment, selecting a display may correspond to selecting one of the electronic apparatus 100 and the external apparatus 200 as a subject for control.

FIG. 4 is a diagram illustrating receiving a command of selecting a display among a plurality of displays displayed on the external apparatus 200 by a touch input on the electronic apparatus 100.

Referring to FIG. 4, when, for example, a two-finger double tab is input, the processor 130 may control the communication circuitry of the communicator 110 to transmit a control command that causes an activated area to be displayed on the external apparatus 200. In other words, the two-finger double tab may be used as a triggering operation.

After one display is displayed as an activated area among the plurality of displays displayed on the external apparatus 200, the processor 130 may change an activated area based on, for example, a two-finger flick motion.

If the activated area pertains to a mirroring display, the processor 130 may control the electronic apparatus 100. For example, the processor 130 may stop mirroring some displays among a plurality of displays which are mirrored in the electronic apparatus 100.

On the other hand, if the activated area is not a mirrored display (in other words, the activated area is a display of the external apparatus 200 itself), the processor 130 may control the external apparatus 200. In this example, the electronic apparatus 100 functions as an apparatus for controlling the external apparatus 200.

FIG. 4 illustrates that a triggering operation and a display selecting operation are carried out by a touch input which is using two fingers but it is not limited thereto. The processor 130 may set various touch inputs as a trigger operation and a display selecting operation. The display selecting operation may be performed by a hovering input as well as a touch input.

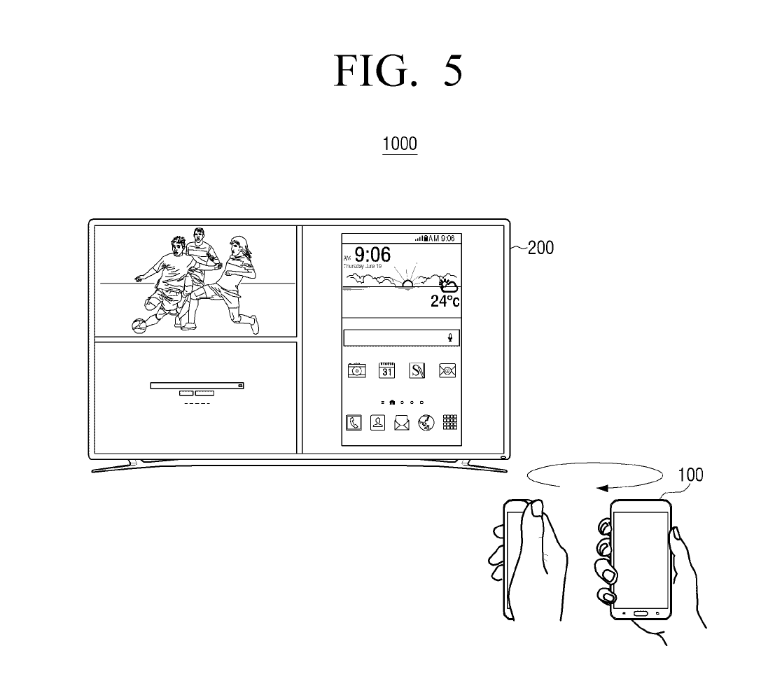

FIG. 5 is a diagram illustrating receiving a command for selecting a display among a plurality of displays displayed on the external apparatus 200 by tilting the electronic apparatus 100 in a certain direction according to an example embodiment.

Referring to FIG. 5, the sensor 160 may sense a direction in which a user tilts the electronic apparatus 100. The processor 130 may control the communication circuitry of the communicator 110 to transmit a control command to change a selected display according to a sensed direction in which the electronic apparatus 100 is tilted to the external apparatus 200. For example, if it is sensed that the electronic apparatus 100 is tilted to the left while the right side display of the external apparatus 200 is activated which is a mirroring display, the processor 130 may control the communication circuitry of the communicator 110 to transmit a control signal that causes the selected display to be changed to an upper-left display. As illustrated in FIG. 5, in case that a plurality of displays are displayed on a direction in which the electronic apparatus 100 is tilted, the processor 130 may select a display based on a pre-set standard. Even though the explanation is based on the assumption that it is set to select an upper display when a plurality of displays are arranged in a direction in which the electronic apparatus 100 is tilted, it is not limited thereto.

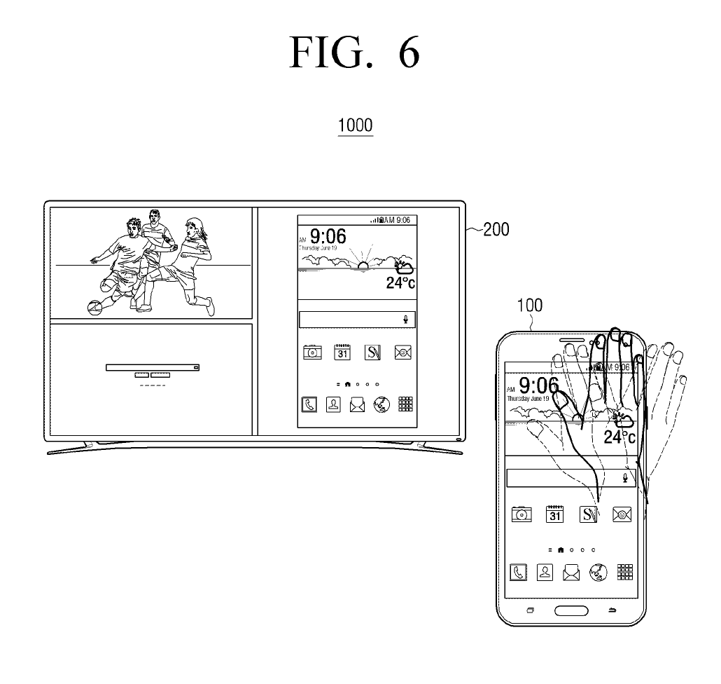

FIG. 6 is a diagram illustrating receiving a gesture input of a user from the electronic apparatus 100 and receiving an input of a command for selecting a display among a plurality of displays displayed on the external apparatus 200.

Referring to FIG. 6, the photographing unit 170 may receive a gesture input of a user. The processor 130 may control the communication circuitry of the communicator 110 to transmit a control command that causes a selected display to be changed based on a pre-set gesture input to the external apparatus 200. FIG. 6 illustrates that the processor 130 selects a display among a plurality of displays of the external apparatus 200 based on a gesture that a user opens his/her hand and moves the hand to the right and to the left.

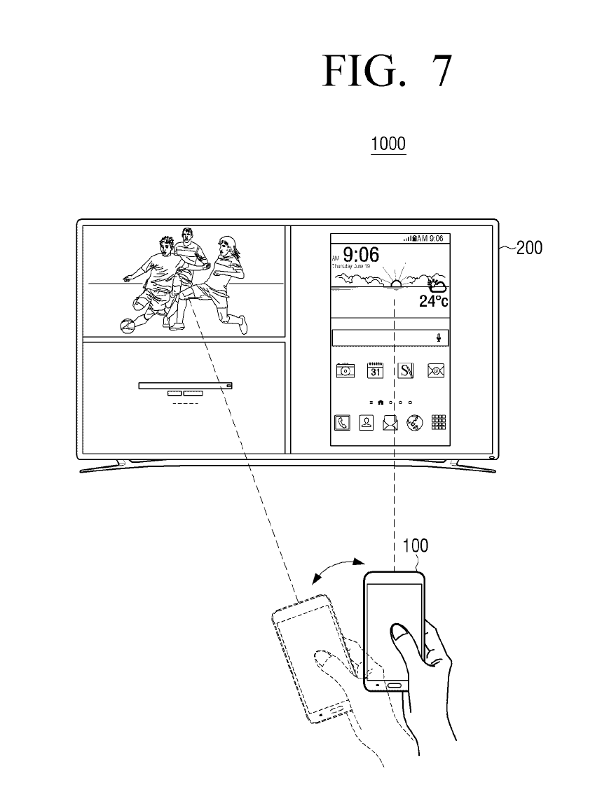

FIG. 7 is a diagram illustrating receiving a command for selecting a display among a plurality of displays displayed on the external apparatus 200 by moving the electronic apparatus 100 to the right and to the left while a touch input is maintained in the electronic apparatus 100. Referring to FIG. 7, the electronic apparatus 100 may operate as a pointing device.

Referring to FIG. 7, the input circuitry of the inputter 140 may receive a touch input of a user. For example, the inputter 140 may receive a touch input of a user through a touch screen connected to the display 120. While the touch input of a user is maintained, the sensor 160 may sense a direction in which the user moves the electronic apparatus 100. The processor 130 may control the communication circuitry of the communicator 110 to transmit a control command that causes a selected display to be changed based on a direction in which the electronic apparatus 100 points.

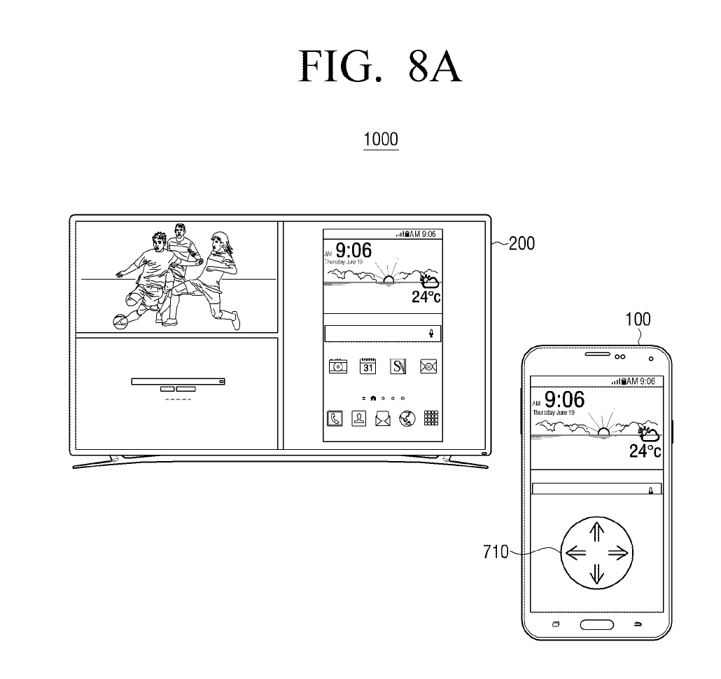

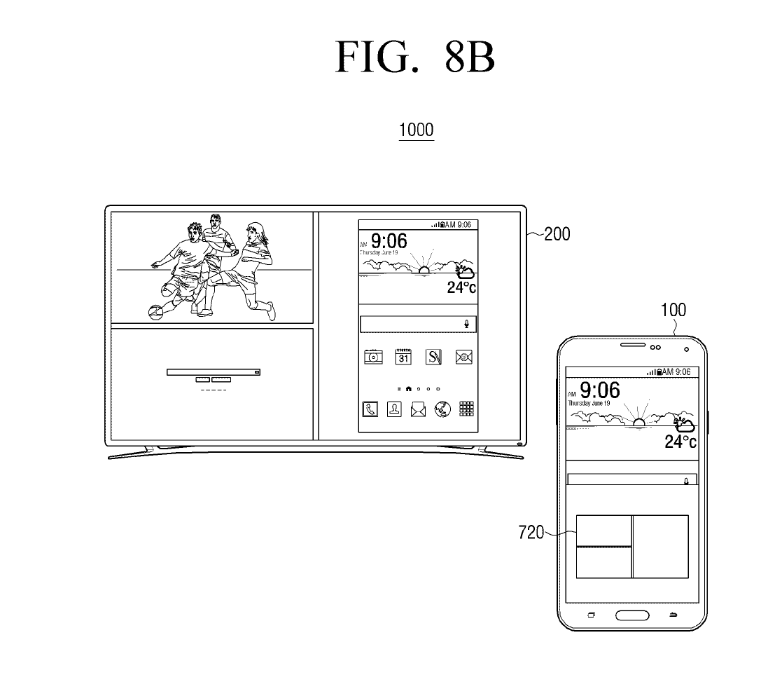

FIGS. 8A and 8B are diagrams illustrating examples of displaying UIs for selecting a display according to various example embodiments. Even though FIGS. 4 to 7 illustrate selecting a display among a plurality of displays displayed on the external apparatus 200 using information such as a direction in which the electronic apparatus 100 is tilted which is sensed by the sensor 160, FIGS. 8A and 8B illustrate selecting a display among a plurality of displays by displaying a separate UI.

According to an example embodiment, the processor 130 may display a UI for receiving selection of a display among a plurality of displays that the external apparatus 200 displays. For example, processor 130 may, as illustrated in FIG. 8A, cause a display to be selected among a plurality of displays by controlling the display 120 to display a UI 710 having an arrow key. For another example, the processor 130 may, as illustrated in FIG. 8B, control the display 120 to display a UI 720 having a form corresponding to the plurality of displays displayed on the external apparatus 200 to select a display among a plurality of displays.

The forms of the UI that the processor 130 may display is not limited to the UI forms illustrated in FIGS. 8A and 8B. Through various UI forms, the processor 130 may receive a command of a user who selects a display among a plurality of displays.

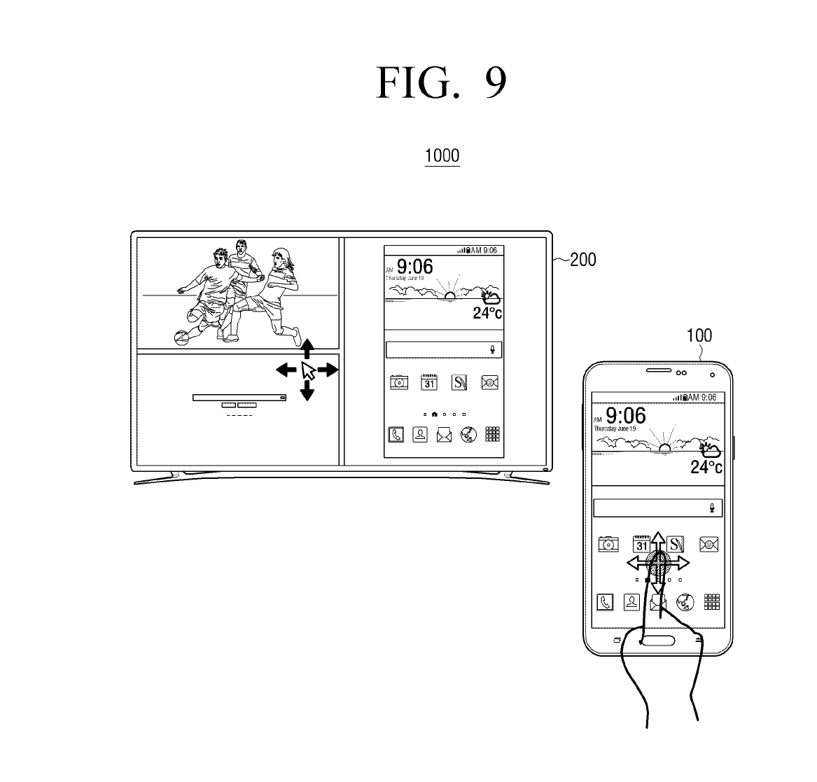

FIG. 9 is a diagram illustrating an example method of the electronic apparatus 100 controlling a cursor of the external apparatus 200 according to an example embodiment.

When a touch input is input to the input circuitry of the inputter 160, the processor 130 may control the communication circuitry of the communicator 110 to transmit a control signal that causes a cursor to be displayed on the external apparatus 200, to the external apparatus 200. When a touch input such as a drag is re-input, the processor 130 may control the communicator 110 to transmit a control signal that causes the cursor to be moved based on a touch input to the external apparatus 200.

For example, the processor 130 may cause the cursor to be displayed only when a display which is not a mirroring display is selected among a plurality of displays displayed on the external apparatus 200. In this example, a touch input to the electronic apparatus 100 may be used as an input to control a cursor movement of the external apparatus 200.

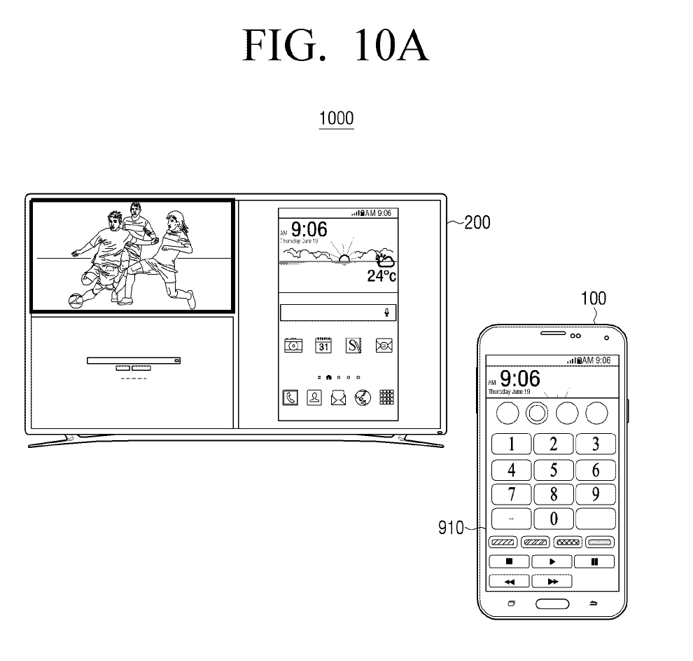

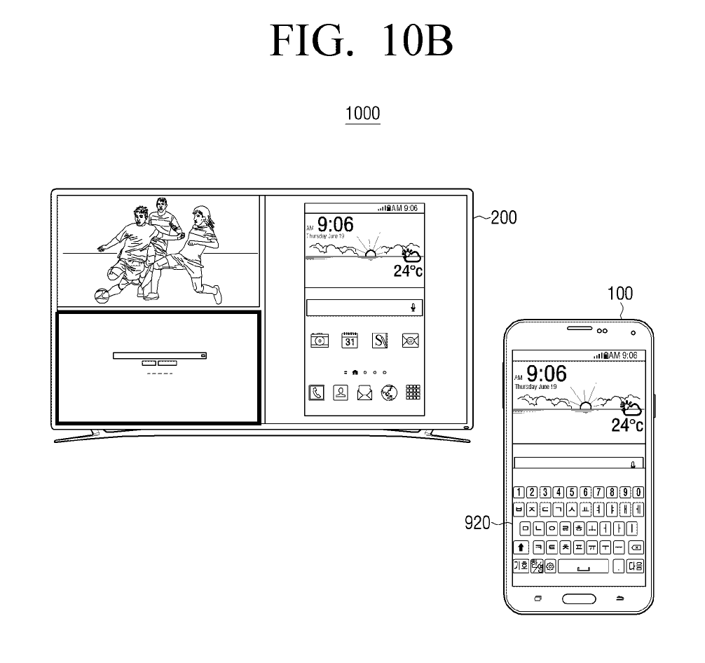

FIGS. 10A and 10B are diagrams illustrating examples of control UIs to control the external apparatus 200 according to an example embodiment.

In a selected display that is not a mirroring display among the plurality displays that the external apparatus 200 displays, the processor 130 may display a control UI to control the external apparatus 200. The processor 130 may cause the control UI to be displayed on the display 120. The processor 130 may cause the control UI not to be included in a mirroring display which is to be transmitted to the external apparatus 200.

Referring to FIG. 10A, the processor 130 may transmit data regarding a first display pertaining to a main screen of the electronic apparatus 100 to the external apparatus 200. The external apparatus 200 may operate a mirroring function by displaying a received first display on one of a plurality of displays. The processor 130 may, while controlling the display 120 to display a second display including a control UI to display, process only data regarding the first display in a mirroring data process. In other words, processor 130 may generate mirroring data in order for the second display not to be displayed (in order to display the first display only).

Accordingly, the processor 130 may cause the external apparatus 200 to mirror only a first display which pertains to the main screen of the electronic apparatus 100 even though a control UI of a TV remote controller form 910 is displayed on the display 120 as illustrated in FIG. 10A.

The processor 130 may process a mirroring signal which is processed not to display a control signal and a control UI for the external apparatus 200 as a separate signal and transmit the signal to the external apparatus 200. For example, the processor 130 may mix two kinds of signals and transmit the mixed signal to the external apparatus 200 through a single communications module. By decoding the mixed signal in the external apparatus 200, a function according to a control signal may be operated at the same time that a mirroring operation is carried out. For another example, the processor 130 may transmit two kinds of signals to the external apparatus 200 through a different communications module. The processor 130 may transmit mirroring data through a WiFi module and transmit a control signal through a Bluetooth module.

According to the various example embodiments, while the mirroring operation is maintained, a function of the external apparatus 200 may be controlled by using the electronic apparatus 100.

According to an example embodiment, the processor 130 may display a control UI according to a content of a selected display. Since a display for a TV broadcasting program is selected, the processor 130 may control the display 120 to display a UI of a TV remote controller form 910 as illustrated in FIG. 10A. In FIG. 10B, since a web browser display is selected, the processor 130 may control the display 120 to display a UI of a key board form 920. For another example embodiment, when the web browser display is selected, the processor 130 may control the display 120 to display a UI of an arrow key or a touch screen to control a cursor.

The processor 130 may control the communication circuitry of the communicator 110 to transmit a control command to highlight around a selected display (or an activated display) among a plurality of displays that the external apparatus 200 displays, to the external apparatus 200. By highlighting a display, a user may more intuitionally and easily recognize which display is selected. By differentiating a highlighting color and a form of a mirroring display from a highlighting color and a form of a display of the external apparatus 200 itself, a user may easily recognize which apparatus he/she can control between the electronic apparatus 100 and the external apparatus 200. For example, the processor 130 may display blue highlight around a mirroring display and red highlight around a display which is not the mirroring display.

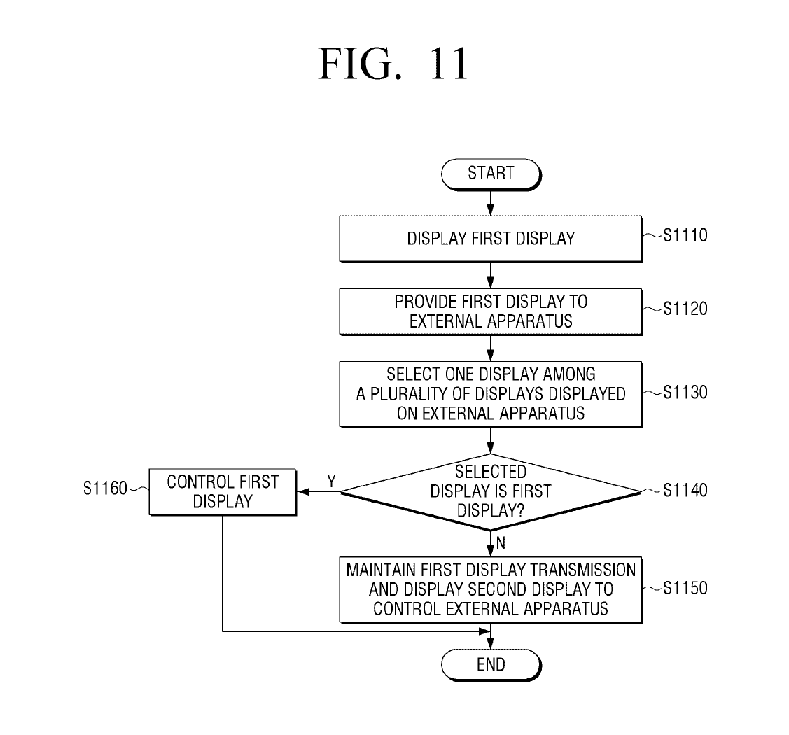

FIG. 11 is a flowchart illustrating an example method of controlling the electronic apparatus 100 according to an example embodiment.

Referring to FIG. 11, the electronic apparatus 100 may display a first display (S1110). For example, a display currently displayed on the electronic apparatus 100 may be a first display. According to a mirroring start command, the electronic apparatus 100 may provide the first display on the external apparatus 200 (S1120). The electronic apparatus 100 may encode the first display and generate mirroring data in a packet. The electronic apparatus 200 may decode the received mirroring data and display the first display on one of a plurality of areas which can display.

The external apparatus 200 may display its own display as well as a mirroring display at the same time. For example, the external apparatus 200 may display a mirroring display, a display for a broadcasting program received from the external apparatus 200 and a web browser display that the external apparatus 200 executed.

The electronic apparatus 100 may select a display among a plurality of displays displayed on the external apparatus 200 (S1130). The electronic apparatus 100 may perform a selecting operation in various methods. For example, the electronic apparatus 100 may display a UI for receiving selection of a display among a plurality of displays that the external apparatus 200 displays. The electronic apparatus 100 may select a display among a plurality of displays through a user input inputted to the UI.

For another example, the electronic apparatus 100 may perform a selecting operation by sensing a direction in which the electronic apparatus 100 is tilted. If a user tilts the electronic apparatus 100 in a certain direction, the electronic apparatus 100 may select a display which is arranged in the direction corresponding to the sensed direction in which the electronic apparatus 100 is tilted among a plurality of displays displayed on the external apparatus 200.

For another example, the electronic apparatus 100 may perform a selecting operation by photographing a user's gesture. If the photographed gesture of the user pertains to a pre-set gesture, the electronic apparatus 100 may select a display among a plurality of displays that the external apparatus 200 displays.

If the selected display does not pertain to a first display which is a mirroring display (S1140-N), the electronic apparatus 100 may maintain a mirroring operation on the first display and display a second display to control the external apparatus 200 (S1150). The second display may include a control UI based on a content of a selected display. For example, if the selected display is a display for a TV program received in the external apparatus 200, the electronic apparatus 100 may display a second display including a control UI of a TV remote controller form. The electronic apparatus 100 may control an operation of the external apparatus 200 through the control UI.

For another example, the electronic apparatus 100 may first receive information about respective contents of a plurality of displays that the external apparatus 200 displays. The electronic apparatus 100 may determine respective forms of control UI to be provided when respective displays are selected by using the received information.

Even when a second display is displayed, the mirroring operation on the first display is maintained. In other words, when the electronic apparatus 100 display a second display, mirroring data provided to the external apparatus 200 may be related to a first display which does not include data of the second display.

On the other hand, if the selected display is the first display which is the mirroring display (S1140-Y), the electronic apparatus 100 may control the first display (S1160).

According to an example embodiment, a user may select an apparatus which is subject to control only with an operation of selecting a display among a plurality of displays displayed on the external apparatus 200.

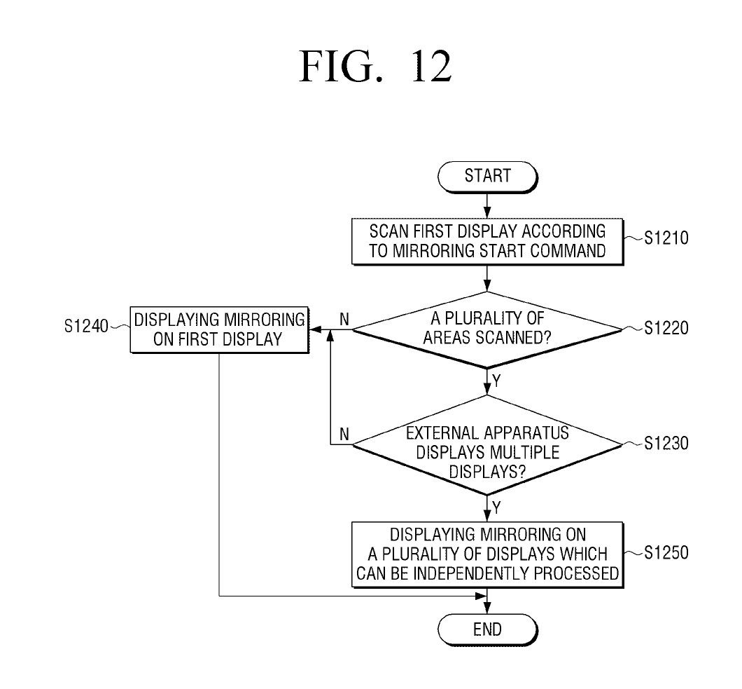

FIG. 12 is a flowchart illustrating an example method of controlling the electronic apparatus 100 according to an example embodiment.

Referring to FIG. 12, the electronic apparatus 100 may scan a first display based on a mirroring start command (S1210). For example, if a plurality of applications are executed in the electronic apparatus 100, the first display may include a plurality of sub displays which can be processed independently. If a plurality of areas are scanned (S1220-Y), the electronic apparatus 100 may determine if the external apparatus 200 can display multiple displays (S1230). If it is impossible to display multiple displays, when a display is divided as a plurality of sub displays, only one display can be mirrored. For example, the electronic apparatus 100 may separate a first display into a plurality of sub displays and transmit information regarding each of the sub displays to the external apparatus 200. The information regarding the sub displays may be information on a size, a location on a first display or image quality of the first display. The external apparatus 200 may scale the received mirroring data and information to be fitted to display ratio of the external apparatus 200 and display each of a plurality of sub displays on a separate area.

If the external apparatus 200 can display multiple displays (S1230-Y), the electronic apparatus 100 may display a mirroring operation on a plurality of displays which can be processed independently (S1250).

On the other hand, if the first display has one area (S1220-N) or the external apparatus 200 cannot display multiple displays (S1230-N), the electronic apparatus 100 may display the mirroring operation on the first display (S1240).

According to the various example embodiments, convenience of a mirroring service between display apparatuses which can provide a multi-display composition may be improved. A user can select a source apparatus or a sink apparatus as a subject for control simply by selecting one of a plurality of displays displayed on the sink apparatus.

According to the various example embodiments, since data regarding a mirroring display and control UI data are separated and processed, the problem of possible interruption on display watching which is caused from a control UI being displayed together on the mirroring display of the sink apparatus may be resolved.

The methods may be recorded in a computer-readable recording medium and embodied as a program command form which can be executed through various computer means. The recording medium readable via the computer may include solely or in combination of a program command, a data file, a data structure, and the like. The program commands recorded in the medium may be specially designed and constituted for the present disclosure but may be program commands which are usable and well-known to people who have common knowledge in the computer software field. The computer readable medium may include a hard disc, a floppy disc, a magnetic media such as a magnetic tape, Compact Disc Read Only Memory (CD-ROM), optical media such as Digital Versatile Disc (DVD), magneto-optical media such as a floptical disc, Read Only Memory (ROM), Random Access Memory (RAM), and a flash memory which is specially configured hardware device for storing and executing program commands. The program commands may include not only machine codes which are made by a compiler, but also high-level language code which can be executed via computer by using interpreter. The hardware device (e.g., including circuitry) may be configured to operate as one or more software modules. Conversely, software modules may be configured to operate as a hardware device.

Although example embodiments have been illustrated and described, it will be appreciated by those skilled in the art that changes may be made to these example embodiments without departing from the principles and spirit of the present disclosure. Therefore, the description of the embodiments is intended to be illustrative, and not to limit the scope of the claims, and many alternatives, modifications, and variations will be apparent to those skilled in the art.

What is claimed is:

1. An electronic apparatus, comprising:
communication circuitry configured to communicate with an external apparatus;
a display configured to display a first display; and
a processor configured to control the communication circuitry to provide the first display of the electronic device on the external apparatus and, in response to a display being selected among a plurality of displays displayed on the external apparatus and the selected display not being the first display, to control the display of the electronic apparatus to display a second display to control the external apparatus while transmission of the first display is maintained.

2. The apparatus as claimed in claim 1, wherein the processor is configured to control the display of the electronic apparatus to display a second display including a control user interface (UI) corresponding to a content of the selected display.

3. The apparatus as claimed in claim 1, wherein the communication circuitry is configured to receive information of contents of each of the plurality of displays displayed by the external apparatus, and
wherein the processor is configured to control the display of the electronic apparatus to display a second display including a control UI corresponding to content information of the selected display.

4. The apparatus as claimed in claim 1, wherein the processor is configured to control the display of the electronic apparatus to display a third display for receiving selection of a display among a plurality displays displayed by the external apparatus.

5. The apparatus as claimed in claim 1, further comprising:
a sensor configured to sense a direction in which the electronic apparatus is tilted,
wherein the processor is configured to select a display among a plurality of displays displayed on the external apparatus based on the sensed direction in which the electronic apparatus is tilted.

6. The apparatus as claimed in claim 1, further comprising:
a camera configured to receive a gesture command,
wherein the processor is configured to select a display among a plurality of displays displayed on the external apparatus based on a pre-set gesture command.

7. The apparatus as claimed in claim 1, wherein the processor is configured to control the communication circuitry to mix a control command input through the second display of the electronic apparatus and data of the first display and to transmit the mixed data to the external apparatus.

8. The apparatus as claimed in claim 1, wherein the processor is configured to control the communication circuitry to separate at least one sub display that can be independently processed by searching the first display and to transmit information of the separated at least one sub display to the external apparatus.

9. The apparatus as claimed in claim 8, wherein the information of the at least one sub display comprises at least one piece of information of a size, a location and image quality of the first display.

10. The apparatus as claimed in claim 1, further comprising:
input circuitry configured to receive a touch input,
wherein the processor is configured to control the communication circuitry to transmit a signal that causes a cursor to be displayed on the external apparatus and a signal that causes the cursor to move based on the touch input.

11. A method of controlling an electronic apparatus, comprising:
displaying a first display;
providing the first display on an external apparatus;
selecting a display among a plurality of displays displayed on the external apparatus; and
displaying a second display on the electronic apparatus to control the external apparatus while transmission of the first display is maintained in response to the selected display not being the first display.

12. The method as claimed in claim 11, wherein the displaying the second display displays a second display on the electronic apparatus including a control UI corresponding to a content of the selected display.

13. The method as claimed in claim 11, further comprising:
receiving information of contents of each of the plurality of displays displayed by the external apparatus,
wherein the displaying the second display displays a second display on the electronic apparatus including a control UI corresponding to content information of the selected display.

14. The method as claimed in claim 11, wherein the selecting a display among a plurality of displays displayed on the external apparatus, comprises:
displaying a third display on the electronic apparatus for receiving selection of a display among a plurality displays displayed by the external apparatus, and
selecting a display among the plurality of displays through an input received on the third display.

15. The method as claimed in claim 11, wherein the selecting a display among a plurality of displays displayed on the external apparatus, comprises:
sensing a direction in which the electronic apparatus is tilted; and
selecting a display among a plurality of displays displayed on the external apparatus based on the sensed direction in which the electronic apparatus is tilted.

16. The method as claimed in claim 11, wherein the selecting a display among a plurality of displays displayed on the external apparatus, comprises:
receiving a gesture command; and
selecting a display among a plurality of displays based on a pre-set gesture command.

17. The method as claimed in claim 11, further comprising mixing a control command input through the second display and data of the first display and transmitting the mixed data to the external apparatus.

18. The method as claimed in claim 11, further comprising:
separating at least one sub display that can be independently processed by searching the first display; and
transmitting information on the separated at least one sub display to the external apparatus.

19. The method as claimed in claim 18, wherein the information of the at least one sub display comprises at least one piece of information of a size, a location and image quality of the first display.

20. The method as claimed in claim 11, further comprising:
receiving a touch input; and
transmitting a signal that causes a cursor to be displayed on the external apparatus and a signal that causes the cursor to move based on the touch input.
